(19) United States
(12) Patent Application Publication
(10) Pub. No.: US 2026/0160543 A1
(43) Pub. Date: Jun. 11, 2026

(54) ROUGHNESS DETERMINATION

(71) Applicant: Applied Materials Israel Ltd., Rehovot (IL)

(72) Inventor: Dor Saddan, Rehovot (IL)

(73) Assignee: Applied Materials Israel Ltd., Rehovot (IL)

(21) Appl. No.: 18/970,739

(22) Filed: Dec. 5, 2024

(51) Int. Cl. G01B 11/30

(52) U.S. Cl. CPC G01B 11/303

(57) ABSTRACT

A roughness determining computerized system, including (i) a memory unit that is configured to store (i.1) a first electron beam image of the structural element, the first electron beam image includes a temporal noise component that is associated with a first acquisition process, and (i,2) temporal noise related information, the temporal noise related information includes at least one out of (a) a second electron beam image acquired by applying a second acquisition process, or (b) temporal noise sensed information generated by a temporal noise sensor that differs from an electron beam related sensor used for generating the first electron beam image; and (ii) a processing circuit configured to decouple the temporal noise component from the first electron beam image based on temporal analysis and spatial analysis related to the first electron beam image and the temporal noise related information.

### BACKGROUND OF THE INVENTION

Samples such as integrated circuits are evaluated by using charged particle tools such as a scanning electron microscope that generate electron beam images. Examples of scanning electron microscope include the SEMVISION™ and the VERITYSEM™, both of which are manufactured by APPLIED MATERIALS™ Inc. of San Jose, California.

The generation of an electron beam image is a noisy process as temporal noises are included in the electron beam image. The temporal noises may be temporal periodic signals and may result from mechanical movements associated with the scanning and/or electrical temporal noises generated during the scanning.

One of the most important feature evaluated by the charged particle tools is a roughness of an edge of a structural element. The roughness is a deviation from the edge as captured in the electron beam image and the ideal shape of the edge.

The temporal noise may be of a magnitude of the roughness—and may negatively impact the accuracy of the measurement of the edge roughness.

The roughness of the edge may be used for various purposes

There is a growing need to at least partially remove the temporal noise from the electron beam image.

### BRIEF SUMMARY OF THE INVENTION

According to an embodiment there is provided a roughness determining computerized system, including:
(i) A memory unit that is configured to store (i.1) a first electron beam image of the structural element, the first electron beam image includes a temporal noise component that is associated with a first acquisition process, and (i,2) temporal noise related information, the temporal noise related information includes at least one out of (a) a second electron beam image acquired by applying a second acquisition process, or (b) temporal noise sensed information generated by a temporal noise sensor that differs from an electron beam related sensor used for generating the first electron beam image; and
(ii) A processing circuit configured to decouple the temporal noise component from the first electron beam image based on temporal analysis and spatial analysis related to the first electron beam image and the temporal noise related information.

According to an embodiment there is provided a method for determining a roughness parameter of a structural element, the method includes:
a. Obtaining a first electron beam image of the structural element, the first electron beam image includes a temporal noise component that is associated with a first acquisition process of the first electron beam image;
b. Obtaining temporal noise related information, the temporal noise related information includes at least one out of (a) a second electron beam image acquired by applying a second acquisition process that differs from the first acquisition process by a temporal parameter, or (b) temporal noise sensed information generated by a temporal noise sensor that differs from an electron beam related sensor used for generating the first electron beam image; and
c. Decoupling the temporal noise component from the first electron beam image based on temporal analysis and spatial analysis related to the first electron beam image and the temporal noise related information.

According to an embodiment there is provided a non-transitory computer readable medium that stores instructions that once executed by a computerized system (such as the roughness determining computerized system) cause the computerized system to determine a roughness parameter of a structural element, by:
a. Obtaining a first electron beam image of the structural element, the first electron beam image includes a temporal noise component that is associated with a first acquisition process of the first electron beam image;
b. Obtaining temporal noise related information, the temporal noise related information includes at least one out of (a) a second electron beam image acquired by applying a second acquisition process that differs from the first acquisition process by a temporal parameter, or (b) temporal noise sensed information generated by a temporal noise sensor that differs from an electron beam related sensor used for generating the first electron beam image; and
c. Decoupling the temporal noise component from the first electron beam image based on temporal analysis and spatial analysis related to the first electron beam image and the temporal noise related information.

### BRIEF DESCRIPTION OF THE DRAWINGS

The subject matter regarded as the invention is particularly pointed out and distinctly claimed in the concluding portion of the specification. The invention, however, both as to organization and method of operation, together with specimen s, features, and advantages thereof, may best be understood by reference to the following detailed description when read with the accompanying drawings in which:

FIG. 1A illustrates an example of a roughness determining computerized system and of an electron beam tool;

FIG. 1B illustrates an example of a roughness determining computerized system, a network, and of an electron beam tool;

FIG. 1C illustrates an example of a roughness determining computerized system, and a storage system;

FIG. 2 illustrates an example of a method; and

FIG. 3 illustrates an example of a step of the method of FIG. 2.

It will be appreciated that for simplicity and clarity of illustration, elements shown in the figures have not necessarily been drawn to scale. For example, the dimensions of some of the elements may be exaggerated relative to other elements for clarity. Further, where considered appropriate, reference numerals may be repeated among the figures to indicate corresponding or analogous elements.

### DETAILED DESCRIPTION OF THE INVENTION

According to an embodiment there is provided a method, a computerized system, and a non-transitory computer readable medium for roughness determining that includes decoupling the temporal noise component from the first electron beam image.

According to an embodiment, the temporal noise introduces artifacts in electron beam images. The locations of the artifacts are dependent on a temporal parameter of acquisition processes of the electron beam image. By acquiring different electron beam images using different values of the temporal parameter (which results in various locations of the artifacts), the artifacts can be detected, and the temporal noise can be removed.

An example of a temporal parameter is a line scan rate of the electron beam image. Assuming that (i) a first electron beam image is acquired at a first line scan rate, (ii) a second electron beam image is acquired at the second scan rate that differs from the first line scan rate, and (iii) that the temporal noise is a periodical noise having a specified period. Under these assumptions—at the first electron beam image and at the second electron beam image the artifacts will appear according to the specified period—but due to the difference in the scan rates —the number of first electron beam image scan lines that are scanned during the specified period (and located between one artifact to another) differs from the number of second electron beam image scan lines that are scanned during the specified period (and located between one artifact to another). On the other hand, in the temporal domain the temporal noise in the same.

According to an embodiment, the temporal noise decupling includes performing temporal analysis and spatial analysis of the different electron beam images to guarantee that differences between electron beam images result from the temporal noise.

According to an embodiment, the temporal noise decupling uses temporal noise sensed information generated by a temporal noise sensor that differs from an electron beam related sensor, and the temporal noise decupling includes performing temporal analysis and spatial analysis of the electron beam image and of the temporal noise sensed information to guarantee that differences between electron beam images result from the temporal noise.

According to an embodiment, the temporal noise decupling is highly accurate, is not bounded by predefined assumptions regarding the artifacts (which provides a coverage to a wide range of temporal noises) and is executed in a power saving manner—as the stages of the process may require an insignificant amount of processing.

According to an embodiment, the temporal noise decupling is followed by determining a roughness parameter of the structural element.

According to an embodiment, one the roughness parameter is determined—it triggers a response such as sending a notice to defined users, providing the roughness parameter to suer using access control, triggering a change in the manufacturing process of the structural element, introducing a change in the manufacturing process of the structural element, declaring the sample that includes the structural element as functional, declaring the sample that includes the structural element as non-functions, scrapping the sample, and the like.

According to an embodiment, the structural element is at least one of a part of a transistor, a transistor, a part of a memory cell, a memory cell, a part of a memory bank, a memory bank, a part of a logic component, be manufactured using lithography, has a nanometric dimension (for example—line width of 0.1-10 nanometers), and the like.

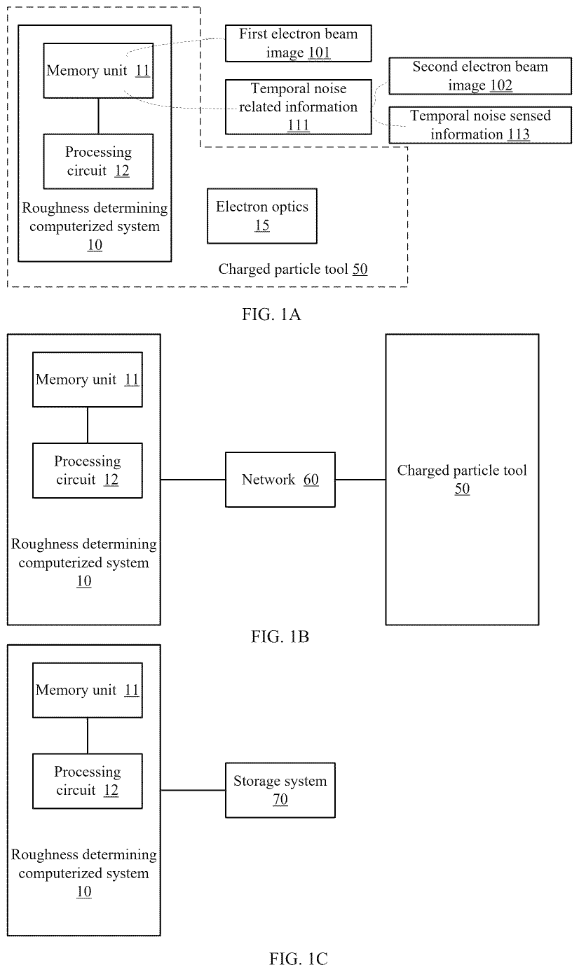

FIGS. 1A-1C illustrate examples of a roughness determining computerized system 10.

According to an embodiment, roughness determining computerized system 10 includes:
a. Memory unit 11 (e. g,. any appropriate computer-readable memory, such as a random access memory “RAM”) that is configured to store:
   i. A first electron beam image 101 of a structural element, the first electron beam image 101 includes a temporal noise component that is associated with a first acquisition process of the first electron beam image.
   ii. Temporal noise related information 111, the temporal noise related information includes at least one out of (a) a second electron beam image 102 acquired by applying a second acquisition process that differs from the first acquisition process by a temporal parameter, or (b) temporal noise sensed information 113 generated by a temporal noise sensor that differs from an electron beam related sensor used for generating the first electron beam image.
b. Processing circuit 12 that is operatively coupled to memory unit and configured to decouple the temporal noise component from the first electron beam image based on temporal analysis and spatial analysis related to the first electron beam image and the temporal noise related information.

According to an embodiment, the memory unit 11 is configured to concurrently store the entire first electron beam image and the entire temporal noise related information, as illustrated in FIGS. 1A, 1B, and 1C. According to an embodiment, the memory unit 11 is configured to concurrently store the entire first electron beam image without storing the temporal noise related information.

According to an embodiment, the memory unit 11 is configured to concurrently store the entire temporal noise related information without storing the first electron beam image.

According to an embodiment, the memory unit 11 is configured to store different portions of the entire first electron beam image and/or different portions of the entire temporal noise related information at different points of time. The storage of said portions at different points in time reduces the memory unit space required per a moment in time.

According to an embodiment, the processing circuit is configured to perform the temporal analysis and the spatial analysis by:
a. Calculating, a first temporal based roughness parameter of the structural element based on the first electron beam image.
b. Calculating, a second temporal based roughness parameter of the structural element based on the temporal noise related information.
c. Calculating, a first spatial based roughness parameter of the structural element based on the first electron beam image.
d. Calculating, a second spatial based roughness parameter of the structural element based on the temporal noise related information.
e. Comparing the first temporal based roughness parameter of the structural element to the second temporal based roughness parameter of the structural element to provide a temporal comparison result.
f. Comparing the first spatial based roughness parameter of the structural element to the second spatial based roughness parameter of the structural element to provide a spatial comparison result; and
g. Determining, based on the temporal comparison result and the spatial comparison result, the roughness parameter of the structural element.

According to an embodiment, the processing circuit is configured to ignore the first electron beam image when (i) the first spatial based roughness parameter of the structural element differs from the second spatial based roughness parameter, and (ii) the first temporal based roughness parameter of the structural element equals the second temporal based roughness parameter.

According to an embodiment, the temporal noise related information is the second electron beam image.

According to an embodiment, the temporal noise related information is the temporal noise sensed information.

According to an embodiment, the processing circuit is configured to calculate the second temporal based roughness parameter of the structural element by:
a. Performing a temporal transformation (for example a temporal Fast Fourier transform) on the temporal noise related information (in order to facilitate the following temporal to spatial transform).
b. Perform a temporal to spatial transformation on the outcome of the temporal transformation (for example applying a temporal to spatial fast Fourier transform).

FIG. 1A illustrates the roughness determining computerized system 10 as being a part of a charged particle tool 60 and includes electron optics 15 that is configured to acquire electron beam images.

FIG. 1B illustrates the roughness determining computerized system 10 as being a stand-alone tool that does not belong to charged particle tool 50—and is in communication with charged particle tool 50 via network 60.

FIG. 1C illustrates the roughness determining computerized system 10 as being a stand-alone tool that does not belong to charged particle tool 50—and is in communication with storage system 70 to obtain the electron beam images acquired by the charged particle tool.

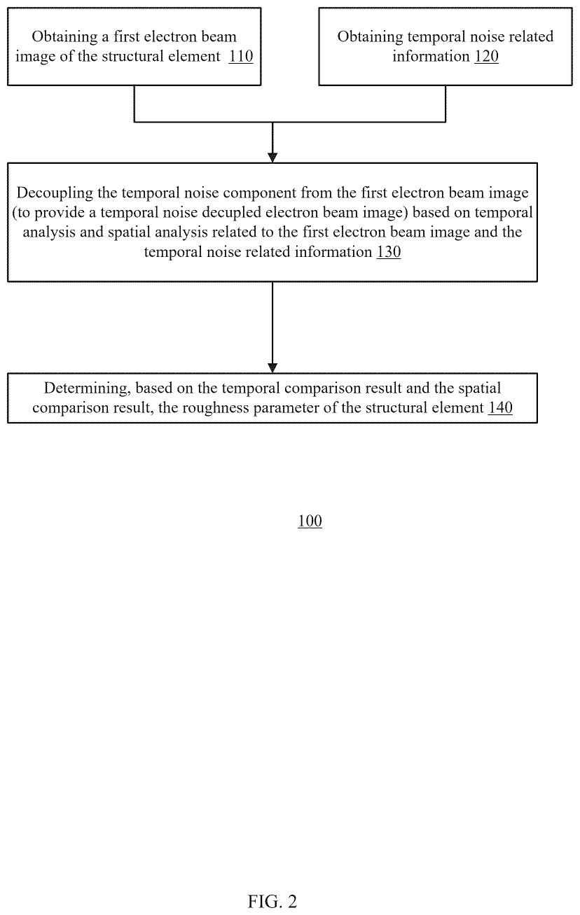

FIG. 2 illustrates an example of method 100 for determining a roughness parameter of a structural element.

According to an embodiment, method 100 includes step 110 and step 120.

According to an embodiment, step 110 includes obtaining a first electron beam image of the structural element, the first electron beam image comprises a temporal noise component that is associated with a first acquisition process of the first electron beam image.

According to an embodiment, step 110 includes acquiring, by electron optics, the first electron beam image.

According to an embodiment, step 120 includes obtaining temporal noise related information, the temporal noise related information comprises at least one out of (a) a second electron beam image acquired by applying a second acquisition process that differs from the first acquisition process by a temporal parameter, or (b) temporal noise sensed information generated by a temporal noise sensor that differs from an electron beam related sensor used for generating the first electron beam image.

According to an embodiment, step 120 includes acquiring, by electron optics, the second electron beam image.

According to an embodiment, step 110 and step 120 are followed by step 130 of decoupling the temporal noise component from the first electron beam image (to provide a temporal noise decupled electron beam image) based on temporal analysis and spatial analysis related to the first electron beam image and the temporal noise related information.

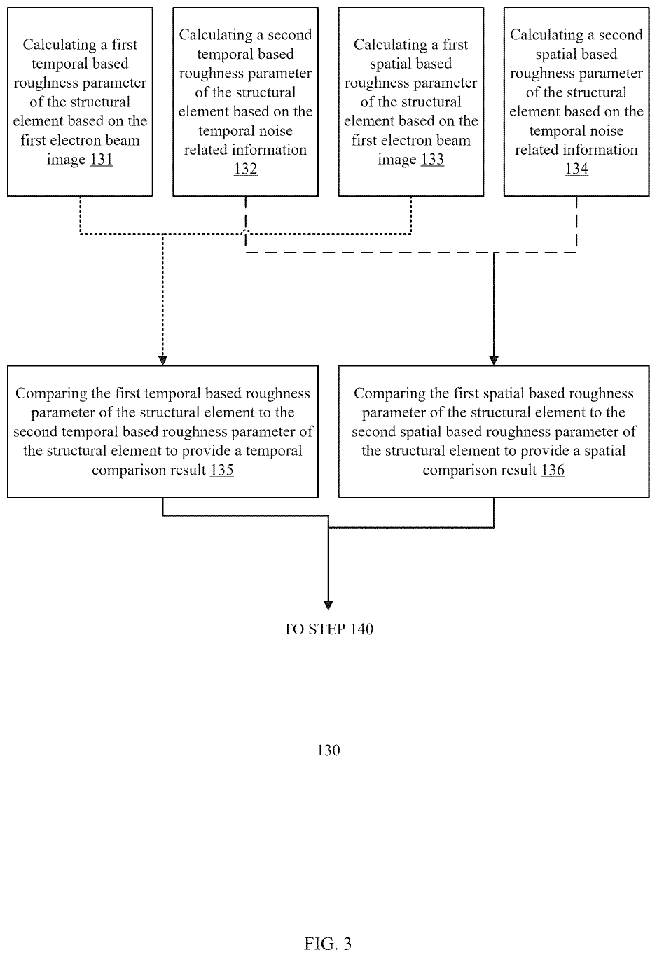

According to an embodiment, step 130 includes performing the temporal analysis and the spatial analysis by (see FIG. 3):
a. Step 131 of calculating a first temporal based roughness parameter of the structural element based on the first electron beam image.
b. Step 132 of calculating a second temporal based roughness parameter of the structural element based on the temporal noise related information.
c. Step 133 of calculating a first spatial based roughness parameter of the structural element based on the first electron beam image.
d. Step 134 of calculating a second spatial based roughness parameter of the structural element based on the temporal noise related information.
e. Step 135 of comparing the first temporal based roughness parameter of the structural element to the second temporal based roughness parameter of the structural element to provide a temporal comparison result.
f. Step 136 of comparing the first spatial based roughness parameter of the structural element to the second spatial based roughness parameter of the structural element to provide a spatial comparison result.

According to an embodiment step 130 is followed by step 140 of determining, based on the temporal comparison result and the spatial comparison result, the roughness parameter of the structural element.

According to an embodiment, step 140 includes ignoring the first electron beam image when (i) the first spatial based roughness parameter of the structural element differs from the second spatial based roughness parameter, and (ii) the first temporal based roughness parameter of the structural element equals the second temporal based roughness parameter.

According to an embodiment, step 140 includes determining the roughness parameter based on the first spatial based roughness parameter and on the second spatial based roughness parameter. For example, applying a weighted sum of the first spatial based roughness parameter and the second spatial based roughness parameter.

According to an embodiment, when there is a first scenario in which the spatial comparison result is indicative of a match and the temporal comparison result is indicative of a mismatch—a weight assigned to the first spatial based roughness parameter exceeds the weight assigned to the second spatial based roughness parameter.

According to an embodiment, when there is a second scenario in which the spatial comparison result is indicative of a match and the temporal comparison result is also indicative of a mismatch—a weight assigned to the first spatial based roughness parameter equals the weight assigned to the second spatial based roughness parameter.

According to an embodiment, when there is a third scenario in which the spatial comparison result is indicative of a mismatch and the temporal comparison result is also indicative of a mismatch—a weight assigned to the first spatial based roughness parameter equals the weight assigned to the second spatial based roughness parameter

According to an embodiment, the weight assigned to the first spatial based roughness parameter under the first scenario exceeds the weight assigned to the first spatial based roughness parameter under each one of the second scenario and the third scenario.

According to an embodiment, the weight assigned to the second spatial based roughness parameter under either one of the first scenario, the second scenario and the third scenario may be zero, substantially zero (for example less than one percent of the weight assigned to the first spatial based roughness parameter), or substantially non-zero.

According to an embodiment, the decoupling occurs under a fourth scenario in which the spatial comparison result is indicative of a mismatch and the temporal comparison result is also indicative of a match.

According to an embodiment, the temporal noise related information is the second electron beam image.

According to an embodiment, the temporal noise related information is the temporal noise sensed information.

According to an embodiment the temporal noise related information is the temporal noise sensed information and step 134 may include:
a. Performing a temporal transformation (for example a temporal Fast Fourier transform) on the temporal noise related information (in order to facilitate the following temporal to spatial transform).
b. Perform a temporal to spatial transformation on the outcome of the temporal transformation (for example applying a temporal to spatial fast Fourier transform).

According to an embodiment, the roughness parameter is a roughness Power Spectral Density (PSD) that provides a representation of the amplitude of a surface's roughness as a function of the spatial frequency of the roughness.

According to an embodiment, the first spatial based roughness parameter is a first spatial PSD, the second spatial based roughness parameter is a second spatial PSD, the first temporal based roughness parameter is a first temporal PSD, the second temporal based roughness parameter is a second temporal PSD.

According to an embodiment, step 140 includes calculating the roughness PSD. For example, by calculating a weighted sum of the first spatial PSD and the second spatial PSD.

According to an embodiment, the roughness parameter is a multi-sigma LER (LER). For example, the multi-sigma LER may be determined based on the PSD.

In the foregoing detailed description, numerous specific details are set forth in order to provide a thorough understanding of the embodiments of the disclosure.

However, it will be understood by those skilled in the art that the present embodiments of the disclosure may be practiced without these specific details. In other instances, well-known methods, procedures, and components have not been described in detail so as not to obscure the present embodiments of the disclosure.

The subject matter regarded as the embodiments of the disclosure is particularly pointed out and distinctly claimed in the concluding portion of the specification. The embodiments of the disclosure, however, both as to organization and method of operation, together with objects, features, and advantages thereof, may best be understood by reference to the following detailed description when read with the accompanying drawings.

Because the illustrated embodiments of the disclosure may for the most part, be implemented using optical and/or electronic components and circuits known to those skilled in the art, details will not be explained in any greater extent than that considered necessary as illustrated above, for the understanding and appreciation of the underlying concepts of the present embodiments of the disclosure and in order not to obfuscate or distract from the teachings of the present embodiments of the disclosure.

Any reference in the specification to a method should be applied mutatis mutandis to a system capable of executing the method, and should be applied mutatis mutandis to a non-transitory computer readable medium that stores instructions that once executed result in the execution of the method.

Any reference in the specification to a system should be applied mutatis mutandis to a method that may be executed by the system, and should be applied mutatis mutandis to a non-transitory computer readable medium that stores instructions that can be executed by the system.

Any reference in the specification to a non-transitory computer readable medium should be applied mutatis mutandis to a method that is implemented by executing instructions stored in the non-transitory computer readable medium, and should be applied mutatis mutandis to a system that is configured to executing instructions stored in the non-transitory computer readable medium.

The term and/or means additionally or alternatively. For example A and/or B means only A, or only B or A and B.

In the foregoing specification, the embodiments of the disclosure have been described with reference to specific examples of embodiments. It will, however, be evident that various modifications and changes may be made therein without departing from the broader spirit and scope of the appended claims.

Moreover, the terms “front,” “back,” “top,” “bottom,” “over,” “under” and the like in the description and in the claims, if any, are used for descriptive purposes and not necessarily for describing permanent relative positions. It is understood that the terms so used are interchangeable under appropriate circumstances such that the embodiments of the disclosure described herein are, for example, capable of operation in other orientations than those illustrated or otherwise described herein.

Any reference to the term “comprising” or “having” or “including” should be applied mutatis mutandis to “consisting” and additionally or alternatively should be applied mutatis mutandis to “consisting essentially of.”

Any arrangement of components to achieve the same functionality is effectively “associated” such that the desired functionality is achieved. Hence, any two components herein combined to achieve a particular functionality may be seen as “associated with” each other such that the desired functionality is achieved, irrespective of architectures or intermedial components. Likewise, any two components so associated can also be viewed as being “operably connected,” or “operably coupled,” to each other to achieve the desired functionality.

Furthermore, those skilled in the art will recognize that boundaries between the above-described operations merely illustrative. The multiple operations may be combined into a single operation, a single operation may be distributed in additional operations and operations may be executed at least partially overlapping in time. Moreover, alternative embodiments may include multiple instances of a particular operation, and the order of operations may be altered in various other embodiments.

Also, for example, in one embodiment, the illustrated examples may be implemented as circuitry located on a single integrated circuit or within a same device. Alternatively, the examples may be implemented as any number of separate integrated circuits or separate devices interconnected with each other in a suitable manner.

Also, for example, the examples, or portions thereof, may implemented as soft or code representations of physical circuitry or of logical representations convertible into physical circuitry, such as in a hardware description language of any appropriate type.

However, other modifications, variations and alternatives are also possible. The specifications and drawings are, accordingly, to be regarded in an illustrative rather than in a restrictive sense.

In the claims, any reference signs placed between parentheses shall not be construed as limiting the claim. The word ‘comprising’ does not exclude the presence of other elements or steps then those listed in a claim. Furthermore, the terms “a” or “an,” as used herein, are defined as one or more than one. Also, the use of introductory phrases such as “at least one” and “one or more” in the claims should not be construed to imply that the introduction of another claim element by the indefinite articles “a” or “an” limits any particular claim containing such introduced claim element to embodiments containing only one such element, even when the same claim includes the introductory phrases “one or more” or “at least one” and indefinite articles such as “a” or “an.” The same holds true for the use of definite articles. Unless stated otherwise, terms such as “first” and “second” are used to arbitrarily distinguish between the elements such terms describe. Thus, these terms are not necessarily intended to indicate temporal or other prioritization of such elements. The mere fact that certain measures are recited in mutually different claims does not indicate that a combination of these measures cannot be used to advantage.

While certain features of the embodiments have been illustrated and described herein, many modifications, substitutions, changes, and equivalents will now occur to those of ordinary skill in the art. It is, therefore, to be understood that the appended claims are intended to cover all such modifications and changes as fall within the true spirit of the invention.

What is claimed is:

1. A roughness determining computerized system, the roughness determining computerized system comprising:
a memory unit that is configured to store:
a first electron beam image of a structural element, the first electron beam image comprises a temporal noise component that is associated with a first acquisition process of the first electron beam image; and
temporal noise related information, the temporal noise related information comprises at least one out of (a) a second electron beam image acquired by applying a second acquisition process that differs from the first acquisition process by a temporal parameter, or (b) temporal noise sensed information generated by a temporal noise sensor that differs from an electron beam related sensor used for generating the first electron beam image; and
a processing circuit configured to decouple the temporal noise component from the first electron beam image based on temporal analysis and spatial analysis related to the first electron beam image and the temporal noise related information.

2. The roughness determining computerized system according to claim 1, wherein the processing circuit is configured to perform the temporal analysis and the spatial analysis by:
calculating a first temporal based roughness parameter of the structural element based on the first electron beam image;
calculating a second temporal based roughness parameter of the structural element based on the temporal noise related information;
calculating a first spatial based roughness parameter of the structural element based on the first electron beam image;
calculating a second spatial based roughness parameter of the structural element based on the temporal noise related information;
comparing the first temporal based roughness parameter of the structural element to the second temporal based roughness parameter of the structural element to provide a temporal comparison result;
comparing the first spatial based roughness parameter of the structural element to the second spatial based roughness parameter of the structural element to provide a spatial comparison result; and
determining based on the temporal comparison result and the spatial comparison result, the roughness parameter of the structural element.

3. The roughness determining computerized system according to claim 2, wherein the processing circuit is configured to ignore the first electron beam image when (i) the first spatial based roughness parameter of the structural element differs from the second spatial based roughness parameter, and (ii) the first temporal based roughness parameter of the structural element equals the second temporal based roughness parameter.

4. The roughness determining computerized system according to claim 2, wherein the temporal noise related information is the second electron beam image.

5. The roughness determining computerized system according to claim 2, wherein the temporal noise related information is the temporal noise sensed information.

6. The roughness determining computerized system according to claim 5, wherein processing circuit is configured to calculate the second temporal based roughness parameter of the structural element by performing a temporal transformation on the temporal noise related information, and by performing a temporal to spatial transformation on an outcome of the temporal transformation.

7. The roughness determining computerized system according to claim 1 further comprising electron optics configured to acquire the first electron beam image.

8. A method for determining a roughness parameter of a structural element, the method comprising:
obtaining a first electron beam image of the structural element, the first electron beam image comprises a temporal noise component that is associated with a first acquisition process of the first electron beam image;
obtaining temporal noise related information, the temporal noise related information comprises at least one out of (a) a second electron beam image acquired by applying a second acquisition process that differs from the first acquisition process by a temporal parameter, or (b) temporal noise sensed information generated by a temporal noise sensor that differs from an electron beam related sensor used for generating the first electron beam image; and
decoupling the temporal noise component from the first electron beam image based on temporal analysis and spatial analysis related to the first electron beam image and the temporal noise related information.

9. The method according to claim 8, wherein the temporal analysis and the spatial analysis comprises:
calculating, a first temporal based roughness parameter of the structural element based on the first electron beam image;
calculating, a second temporal based roughness parameter of the structural element based on the temporal noise related information;
calculating, a first spatial based roughness parameter of the structural element based on the first electron beam image;
calculating, a second spatial based roughness parameter of the structural element based on the temporal noise related information;
comparing the first temporal based roughness parameter of the structural element to the second temporal based roughness parameter of the structural element to provide a temporal comparison result;
comparing the first spatial based roughness parameter of the structural element to the second spatial based roughness parameter of the structural element to provide a spatial comparison result; and
determining, based on the temporal comparison result and the spatial comparison result, the roughness parameter of the structural element.

10. The method according to claim 9 further comprising ignoring the first electron beam image when (i) the first spatial based roughness parameter of the structural element differs from the second spatial based roughness parameter, and (ii) the first temporal based roughness parameter of the structural element equals the second temporal based roughness parameter.

11. The method according to claim 9, wherein the temporal noise related information is the second electron beam image.

12. The method according to claim 9, wherein the temporal noise related information is the temporal noise sensed information.

13. The method according to claim 12, wherein the calculating of the second temporal based roughness parameter of the structural element comprises performing a temporal transformation on the temporal noise related information, and by performing a temporal to spatial transformation on an outcome of a temporal transformation.

14. The method according to claim 8 further comprising acquiring the first electron beam image by electron optics.

15. A non-transitory computer readable medium that stores instructions that once executed by a computerized system cause the computerized system to determine a roughness parameter of a structural element, by:
obtaining a first electron beam image of the structural element, the first electron beam image comprises a temporal noise component that is associated with a first acquisition process of the first electron beam image;
obtaining temporal noise related information, the temporal noise related information comprises at least one out of (a) a second electron beam image acquired by applying a second acquisition process that differs from the first acquisition process by a temporal parameter, or (b) temporal noise sensed information generated by a temporal noise sensor that differs from an electron beam related sensor used for generating the first electron beam image; and
decoupling the temporal noise component from the first electron beam image based on temporal analysis and spatial analysis related to the first electron beam image and the temporal noise related information.

16. The non-transitory computer readable medium according to claim 15, that stores instructions that once executed by the computerized system cause the computerized system to perform the temporal analysis and the spatial analysis by:
calculating, a first temporal based roughness parameter of the structural element based on the first electron beam image;
calculating, a second temporal based roughness parameter of the structural element based on the temporal noise related information;
calculating, a first spatial based roughness parameter of the structural element based on the first electron beam image;
calculating, a second spatial based roughness parameter of the structural element based on the temporal noise related information;
comparing the first temporal based roughness parameter of the structural element to the second temporal based roughness parameter of the structural element to provide a temporal comparison result;
comparing the first spatial based roughness parameter of the structural element to the second spatial based roughness parameter of the structural element to provide a spatial comparison result; and
determining, based on the temporal comparison result and the spatial comparison result, the roughness parameter of the structural element.

17. The non-transitory computer readable medium according to claim 16, that stores instructions that once executed by the computerized system cause the computerized system to ignore the first electron beam image when (i) the first spatial based roughness parameter of the structural element differs from the second spatial based roughness parameter, and (ii) the first temporal based roughness parameter of the structural element equals the second temporal based roughness parameter.

18. The non-transitory computer readable medium according to claim 16, wherein the temporal noise related information is the second electron beam image.

19. The non-transitory computer readable medium according to claim 16, wherein the temporal noise related information is the temporal noise sensed information.

20. The non-transitory computer readable medium according to claim 19, that stores instructions that once executed by the computerized system cause the computerized system to calculate the second temporal based roughness parameter of the structural element by performing a temporal transformation on the temporal noise related information, and by performing a temporal to spatial transformation on an outcome of the temporal transformation.
